(19) United States
(12) Patent Application Publication
(10) Pub. No.: US 2007/0089636 A1
(43) Pub. Date: Apr. 26, 2007

(54) Magnetic levitation transport system

(76) Inventor: Jose L. Guardo JR., Cebu City (PH)

Correspondence Address: Mr. Walter J. Tencza Jr.;Suite 3, 10 Station Place, Metuchen, NJ, 08840, US

(21) Appl. No.: 11/449,301

(22) Filed: Jun. 8, 2006

Related U.S. Application Data
(63) Continuation-in-part of application No. 10/499,397, filed on Jun. 17, 2004, now Pat. No. 7,059,252.

(51) Int. Cl. B60L 13/04

(52) U.S. Cl. 104/281

(57) ABSTRACT

A magnetic levitated transport system comprising a magnetic levitation guideway, and a magnetic levitation vehicle traversing said magnetic levitation guideway. The magnetic levitation guideway may be defined by a pair of continuous parallel vehicle levitation guideways, each having a plurality of spaced apart rotating passive magnetic disc assemblies, one or more linear guideway electric generators interconnecting said passive magnetic disc assemblies, and a magnetic-ferromagnetic attractive propulsion guideway disposed co-extensive with said magnetic levitation guideway. The magnetic levitation vehicle may be defined by a vehicle body, a magnetic suspension stabilizer disposed at the lower opposing sides of said vehicle body, including a plurality of electromagnetic array spinning discs spacedy disposed in a linear pattern thereof.

### CROSS REFERENCE TO RELATED APPLICATION(S)

The present application is a continuation in part of and claims the priority of U.S. patent application Ser. No. 10/499,397, titled “MAGNETIC LEVITATION CAR”, inventor Jose L. Guardo JR., filed on Sep. 14, 2004, which claims the priority of international patent application titled “MAGNETIC LEVITATION CAR”, PCT application no. PCT/PH03/00005, international filing date May 20, 2003. The present application claims the priority of PCT application no. PCT/PH03/00005 and also claims the priority benefit of PCT application no. PCT/PH2005/000017, international filing date Aug. 18, 2005, applicant Jose Guardo, Jr.

### FIELD OF THE INVENTION

The present invention relates generally to magnetic levitation transport systems.

### BACKGROUND OF THE INVENTION

The concept of a magnetic levitation vehicle has been around for more than sixty years, and was a brainchild of a German scientist named Hermann Kemper. On Aug. 14, 1934, he received a patent for the magnetic levitation of vehicles in Germany.

In the mid 1900s, Britain became the first country to introduce a magnetic levitation service. It was to link two terminals at Birmingham airport about four hundred meters long and at a top speed of about ten miles per hour (mph). However it was recently replaced with a bus service due to difficulty of getting spare parts.

Since then, there has been a lot of research and experiments for Magnetic Levitation Vehicles in countries like Germany, Japan, and the United States of America. The German TRANSAPID Electro Magnetic System (EMS) is now successfully operational for commercial use in China and connects the Podung Airport to Shanghai metropolis. The journey time will be no more than sixty minutes for the two hundred ninety-two kilometers giving rise to an impressive two hundred ninety-two kilometers per hour average speed.

In Japan, after fundamental tests in the laboratory to verify the feasibility of high-speed running at five hundred kilometers per hour (kph), the construction work of a seven kilometer test track began in Japan's Miyazaki Prefecture in 1975. The manned two-car vehicle registered a speed of 400.8 kph in 1987. In 1997, the project in a three-car vehicle set world speed records, attaining a maximum speed of 531 kph in a manned vehicle run on December 12 and a maximum speed of 550 kph in an unmanned vehicle on December 24. On Apr. 14, 1999, a five-car vehicle set surpassed the speed record, attaining a maximum speed of 552 kph in a manned vehicle run.

The principle of a magnetic vehicle is that it floats on a magnetic field using the principle of electromagnetics, superconductivity, Halbach Array (invented by Klaus Halbach) permanent magnets and electromagnetic array and is propelled by a linear synchronous, induction motor or dynamic electromagnetic wheel. A magnetic vehicle follows guidance tracks with magnets. These vehicles are often referred to as magnetically levitated, which is abbreviated, to maglev.

Maglev is a system in which the vehicle runs levitated from the guide way (corresponding to the rail tracks of conventional railways) by using electromagnetic forces, super conducting magnets, Halbach Array permanent magnets or electromagnetic array on board the vehicle and coils on the ground. A maglev vehicle levitates about ten mm (millimeters) or more above the guide way on a magnetic flux cushion depending on the levitation principle used on the maglev system. It is propelled by the guide way itself rather than an onboard engine by changing magnetic fields. Once the vehicle is pulled into the next section the magnetism switches so that the vehicle is pulled on again. The electro-magnets run the length of the guide way.

The primary advantage of a magnetic levitated vehicle is maintenance, because the vehicle floats along a frictionless magnetic guide way. There is no contact with the ground and therefore no need for any moving plates. As a result there are no components that could wear out. This means that vehicles and tracks would need no maintenance at all. The second advantage is that because maglev vehicles float; there is no friction and noise. Finally, as a result the maglev vehicle can travel extremely fast i.e. about 500 kph or more depending on the environment it is cruising. If the vehicle travels along a vacuum, it can attain up to 800 kph or more because there is no wind resistance acting against its body.

However, there are several disadvantages with maglev vehicles. Maglev guide paths are bound to be more costly than conventional steel railways. Most existing maglev systems require a continuous magnetic, electromagnetic and super conducting plate that runs the length of the guideway. This means it is costly to build just the guideway system. The other disadvantage is lack of existing infrastructure. For example, if a high-speed line between two cities is built, then high-speed maglev vehicles can only serve both cities but would not be able to serve other lines or normal railways branching out therefrom which require normal speed. This means that maglev vehicles are strictly limited only to high-speed lines and not flexible enough to serve other lines.

Although Maglev technology has been around for quite some time now, its application has been concentrated on the use of mass transportation and the cost to build it is very expensive especially using superconductivity or electromagnetic principles of levitation.

Currently there are three major categories of Maglev Systems, the EDS, the EMS and the Inductrak. The following are some of the drawbacks of these existing Maglev Systems now already in commercial application, on the test line and on in the laboratory:

A. EDS: Electro Dynamic System(Japanese Superconconducting Maglev)

1. The Electro Dynamic System (or Japanese Superconducting Maglev) is based on the principle of superconductivity to attain magnetic levitation. For this technology a frigid temperature is needed to attain magnetic levitation. In Japan they are using a cryogenic or refrigeration system with liquid nitrogen and helium on board the vehicle and on the track or maglev guideway to attain superconductivity making the vehicle heavier and with complicated sub-systems;
2. Since the EDS system requires superconducting, the passengers must be shielded so they will not be exposed to a high magnetic field. As a result, an electromagnetic field (EMF) insulation system would be needed for protection.
3. Although the levitation is higher than the German Transrapid EMS System at about eight inches because of superconductivity, the need to maintain the right temperature is crucial. Absence of this factor, would affect the levitation performance. As a result, the EDS system becomes applicable only in cold countries like Japan or the Northern Hemisphere and cannot be used in tropical or warm countries. Building an EDS system in warm countries would only mean higher operational and maintenance cost.
4. For the EDS system, the levitation and propulsion system is integrated, making it very difficult to assess and trouble shoot where a system fails.
5. The EDS system needs auxiliary wheels during initial propulsion and landing.
6. The guideway used in the EDS system is bulky and massive and very complicated to build or maintain and needs refrigeration system making it expensive.
7. Because of the guideway design for the EDS system, it is difficult for the vehicle to make sharp curves and U turns.
8. The propulsion and levitation uses the same guideway system.
   B. EMS: Electromagnetic System or EMS German version(German Transrapid Electromagnetic Maglev)
1. The EMS system is based on the principle of electromagnetism to attain attractive magnetic levitation. Therefore, the EMS system requires an on board battery pack or power system to attain and maintain levitation and propulsion. Without power, the vehicle will not levitate, and if there is a power failure while the vehicle is running at high speed, this might result to in a possible fatal and dangerous magnetic levitation crash.
2. As a result, the EMS system is likewise expensive as there is a need to maintain additional operational cost on the power system for its levitation. In fact, there is a need to constantly monitor the air gap between the vehicle and the guideway. Monitoring is done using sensors and transmission antenna to the control station to make sure that everything is on the right track. Failure of one of these systems can be dangerous.
3. For the EMS system, there's a lot of subsystems needed to monitor the levitation and propulsion system and the levitation is a very low ten millimeters (mm). Sometimes during propulsion the gap between the guideway and the electromagnetic propulsion and levitation device is at a critical one millimeter (mm) gap of clearance. Any wind or natural disturbances may cause fatal contact to the guideway.
4. For propulsion, the EMS system uses a linear synchronous motor.
5. The guideway is simplified but needs electricity which is distributed precisely where the vehicle is located. setup that requires a lot of electronic and navigational controls and power.
6. With the EMS system, the levitation and propulsion system is integrated in one location. These means that it will be difficult to assess and trouble shoot where a system failed.
7. The EMS system needs constant electricity supply to operate the propulsion and the levitation systems, rendering it necessary to have a battery power system on board, making the vehicle much heavier.
   EMSAV: Electro Magnetic System American Version
   (American Inductrack Maglev)
1. The EMSAV or EMS American Verision system is based on the principle of electromagnetism to attain repulsive magnetic levitation. The levitation is attained during propulsion at a certain speed as a result of induced electricity produced by the short-circuited coils and the Halbach array permanent magnets.
2. As a result the system is less expensive than the previously mentioned two maglev systems (the EDS and EMS German version).
3. Like the two other systems, the levitation and propulsion systems are integrated making it difficult to conduct trouble shooting on defective systems.
4. The EMS American version uses a linear induction motor for propulsion.
5. The EMS American version needs auxiliary wheels during initial propulsion and landing.

### SUMMARY OF THE INVENTION

The present invention in one or more embodiments, relates to a magnetic levitation vehicle that levitates using a spin stabilized magnetic disc assembly using permanent magnets arranged in a magnetic-electromagnetic array or in a U-shaped or C-shaped array, in an intermittent arrangement, and a dynamic magnetic suspension stabilizer that will attain stable and economical magnetic levitation using permanent magnets that are allowed to spin freely combined with a linear solenoid assembly that will act as a secondary repulsive levitation system and linear electric generator at the same time.

The present invention in one or more embodiments provides a a new generation of maglev systems which will answer the major draw backs of existing maglev systems developed in countries like Germany, Japan, and the USA. This new dynamic maglev system will certainly transform the way people move in the future because part of the system uses only permanent magnets that are made to spin freely to attain stable magnetic levitation that will make levitation systems cheaper than superconductivity systems or electromagnetic systems developed in Japan and Germany, respectively. At the same time the present invention in one or more embodiments uses the same moving magnetic field on the vehicle to generate electricity if the vehicle is engaged on a solenoid linear iron-less core conductor guideway system. This added functionality of a maglev system is an important breakthrough in urban or countryside electric power generation because the present invention in one or more embodiments allows the magnetic guideway to become an electric generating device that may power the lights and operation of the maglev system and optionally may also power a suburb or a city. This will also compensate in time for the cost of building this exorbitant maglev guideway system because of the potential revenue the maglev operator may gain in this unorthodox means to generate renewable and sustainable artificial alternative electricity generator. A system in accordance with one or more embodiments of the present invention can be seamlessly integrated in an urban environment or countryside for use as a source of free electricity in the future at the same time as a means of cheap and efficient mass transportation.

One of the primary objects of this invention therefore is to provide a magnetic levitated transport system that solves the drawbacks inherent to the existing maglev vehicle systems.

Another object of this invention is to provide a magnetic levitation transport system using a Segmented Electromagnetic Array (SEMA) synchronous motor or servo motor in one roof for high speed propulsion or low speed digital propulsion.

Another object of this invention is to provide a magnetic levitated vehicle that runs on a linear magnetic generator, using intermittent spaced apart spinning permanent magnetic discs in a Halbach Array, U-shaped or C-shaped array or a magnetic-electromagnetic Array configuration.

Still an object of this invention is to provide a magnetic levitation transport system that is environment friendly since no air pollutants come off the vehicle nor noise that is being produced thereof because one or more embodiments of the present invention use an on-board battery recharged continuously using an on-board linear alternator or can be powered by hydrogen fuel-cell or hydro-fuel-cell system using on-board water electrolysis and fuel-cell energy generator ecosystem or can be powered from an external power supply.

Another object of this invention is to provide a magnetic levitation transport system having the ability to produce electricity as the moving vehicle body is engaged in the linear solenoid iron-less core coil conductor assembly located along the guideway that will act as a linear electric generator apparatus and at the same time a secondary levitation guidance device. The electric output can be stored to re-chargeable back-up or standby batteries, or other applications as deemed necessary.

Yet, another object of this invention is to provide a magnetic levitation transport system having a polarity similar to the polarity of the magnetic guideway using permanent magnets in a spinning circular Halbach Array, Alternating Recessed Magnetic array, circular U-shaped or C-shaped array or circular magnetic-Electromagnetic Array, that when engaged, the vehicle attains stable repulsive magnetic levitation or is suspended in mid-air on a magnetic flux cushion. The spinning of both the guideway and the magnetic suspension stabilizer on the vehicle's body will make the levitation stable using rare earth permanent magnets in a circular Halbach Array or any Magnetic Array configuration.

### BRIEF DESCRIPTION OF THE DRAWINGS

FIG. 1 is a perspective view of the present invention for a magnetic levitation transport system;

FIG. 2 is a perspective view showing the inner lower portion of the magnetic levitation vehicle;

FIG. 3 is a fragmentary plan view of FIG. 1;

FIG. 4 is a fragmentary illustrative side view of the magnetic levitation transport system showing particularly the inner parts thereof and the magnetic levitation guideway;

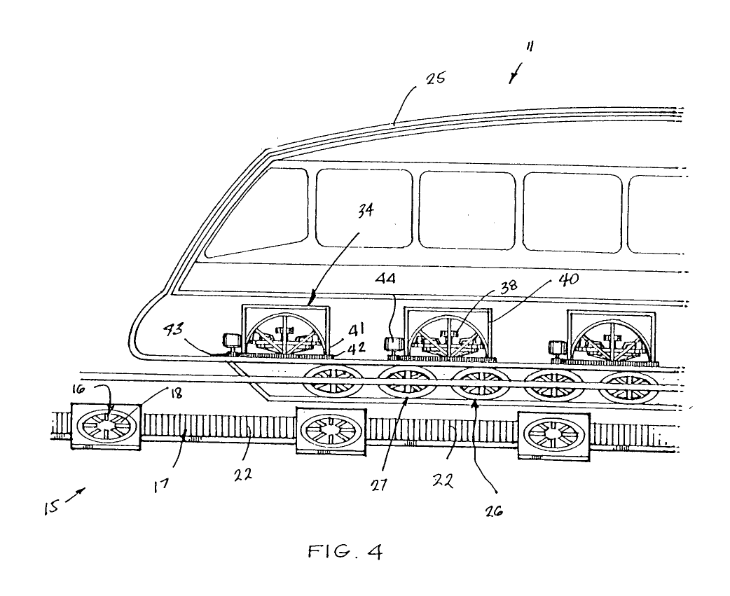

FIG. 5 is a sectional view taken along line 5-5 of FIG. 1 with the magnetic propulsion wheel assemblies in the engaged mode;

FIG. 6 is an enlarged view of FIG. 5 with the magnetic propulsion wheel assemblies in the disengaged mode:

FIG. 7 is a detailed view of the magnetic propulsion wheel assembly; and

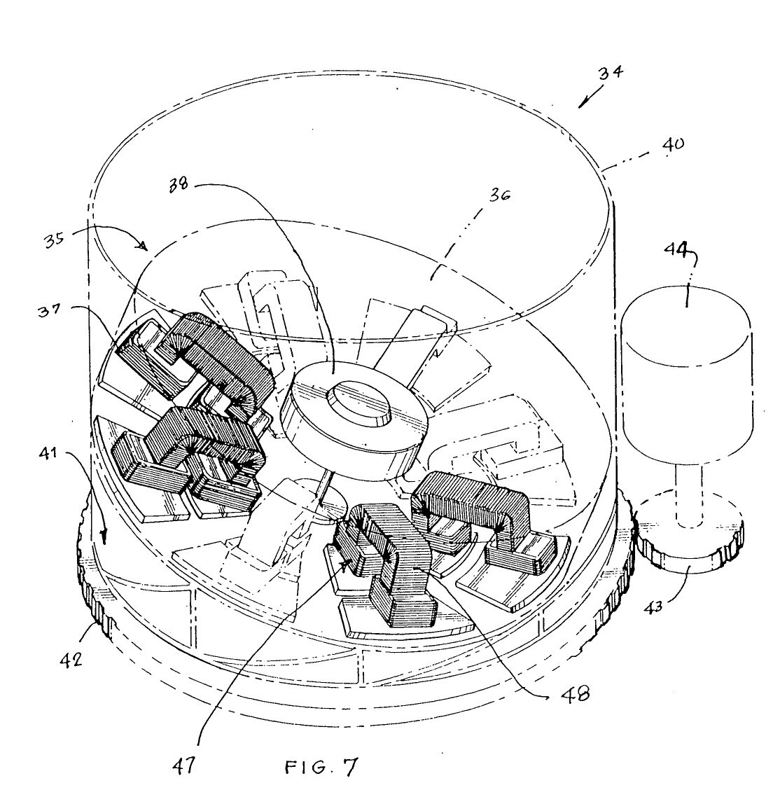

FIG. 8 is a sectional view of an alternative embodiment of the magnetic levitation vehicle.

### DETAILED DESCRIPTION OF THE DRAWINGS

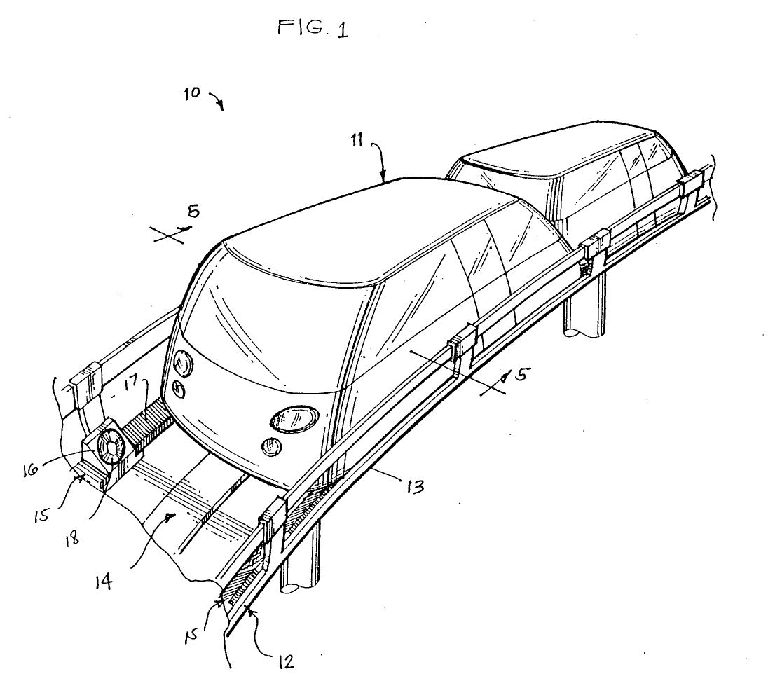

FIG. 1 shows a magnetic levitation transport system generally designated as reference numeral 10. Said magnetic levitation transport system 10 comprises a magnetic levitation vehicle 11 traversing along an inclined magnetic levitation guideway 12 supported by a concrete support with physical contact guide reinforcement 13 and a magnetic-ferromagnetic attractive propulsion guideway in North-South-North-South magnetic array configuration 14 co-extensive with said magnetic levitation guideway 12.

Said magnetic levitation guideway 12 is comprised of a pair of continuous parallel vehicle levitation guideways 15, each having a plurality of spaced apart passive magnetic disc assemblies 16 interconnected by linear guideway electric generators 17.

Each of said passive magnetic disc assemblies 16 is defined by a magnetic disc 18 comprised of a plurality of permanent magnets 19 disposed in a circular magnet array such as a Halbach array, Alternating Recessed Magnetic array, or any magnetic-electromagnetic array. Said magnet array could also be a U-shaped permanent magnet being wound by copper wires. Said magnetic disc 18 is rotatably enclosed by an electromagnetic bearing 20 or any other type of bearing that serves the purpose. Each passive magnetic disc assembly 16 is supported in a concrete or reinforced plastic housing 21 inclinedly secured to said concrete support 13.

Said linear guideway electric generators 17 are stationary located between the spaced apart passive magnetic discs assemblies 16 along said magnetic levitation guideway 12 and are respectively made of an iron-less core (not shown) and copper coils 22 would around said iron-less core.

The magnetic-ferromagnetic attractive propulsion guideway 14 which is laid out in between said pair of parallel vehicle levitation guideways 15 on said concrete support 13 is basically a continuous I-beam 23 mounted with a propulsion guideway alternating North-South-North-South magnets 24 mounted thereon.

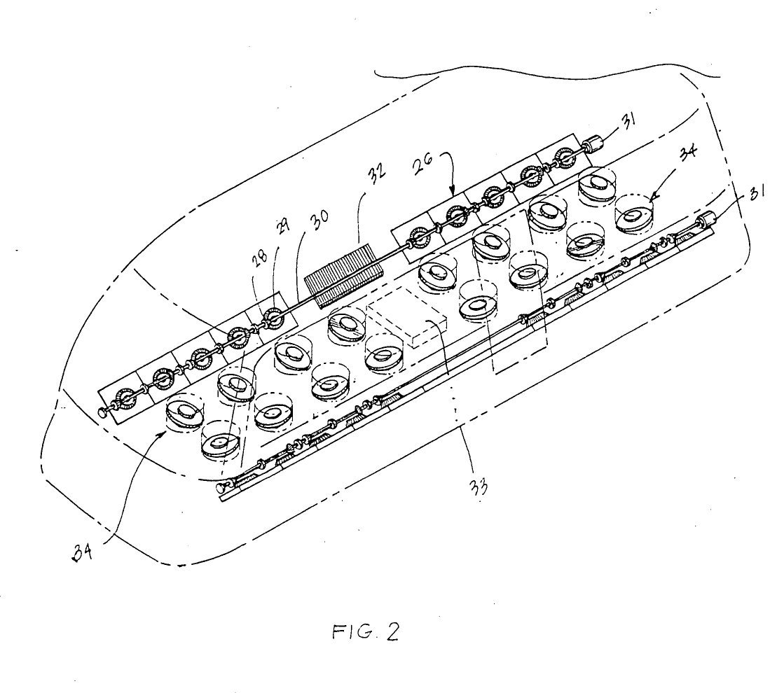

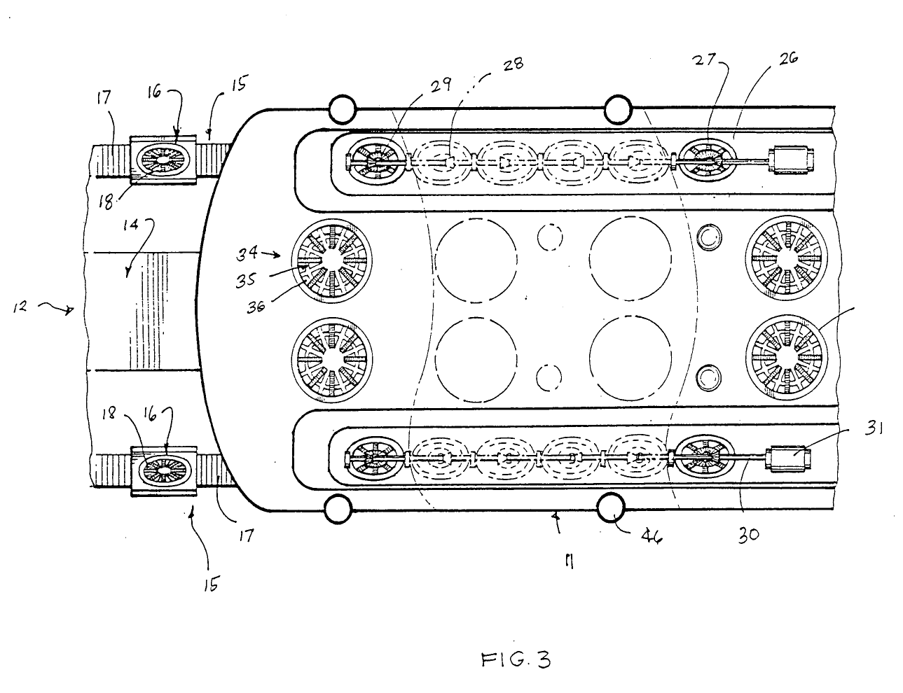

The magnetic levitation vehicle 11 includes a conventional vehicle body 25 being provided with an inclined magnetic suspension stabilizer 26 at the lower opposing sides of said train body 25 and in communication with the respectively parallel vehicle levitation guideways 15. Said magnetic suspension stabilizer 26 is being defined by a plurality of magnetic array spinning discs 27 spacedly disposed in a linear pattern thereof. Said magnetic array spinning discs 27 react with said passive magnetic discs assemblies 16 of said vehicle levitation guideways 15 in a repulsive behavior resulting in the levitation of said vehicle body 25. Each of said magnetic array spinning discs 27 is arranged in a circular magnet array such as Halbach array, Alternating Recessed Magnetic array, or magnetic-electromagnetic array. Said magnet array could also be of U-Shape permanent magnet being wound by copper wires. The magnetic array spinning discs 27 are respectively coupled with a pinion and gear combination 28 and 29 that are securedly mounted on a common axle 30 which in turn is drivenly coupled to motor 31. Said motor 31 causes the rotation of said magnetic array spinning discs 27 at a predetermined speed. As shown in FIGS. 2 and 3, the pinions 28 of the adjacent magnetic array spinning discs 27 are opposedly oriented so that each of the magnetic array spinning discs 27 would rotate in a different direction with respect to the adjacent magnetic array spinning discs. This counter rotation is necessary to prevent the sideward movement effect of the vehicle body 25 being brought by the rotation of the spinning discs 27.

The degree of inclination of the magnetic suspension stabilizer 26 is similar to the inclination of the magnetic discs 18 of the passive magnetic levitation guideway 12. The magnetic discs 18 would rotate dynamically when engaged with a passing maglev vehicle magnetic suspension stabilizer 26 due to the forces of repulsive and attractive magnetic force of engaged Halbach or Magnetic Array spinning disc, frictionless torque and gravity. This is the primary passive magnetic suspension levitation that will allow the maglev vehicle to suspend in a frictionless magnetic space with or without the use of electricity. The magnetic array spinning discs 27 makes the levitation higher or stronger depending on the load or use of the vehicle. This can be so if the magnetic array spinning discs 27 are charged with high voltage of electric current. The stronger the current the higher the levitation and vice versa.

At the same time the sloping design of the passive magnetic levitation guideway 12 makes the vehicle slide towards the center of gravity providing balance and stability of magnetic levitation as shown in the drawings. This alternating or intermittent levitation guideway system will cut up to 50-70% of the required permanent magnets on the guideway compared to using the conventional levitation technique. This means that the cost on building the magnetic guideway will be reduced.

Moreover, the linear guideway electric generators 17 would generate electricity as the magnetic array spinning discs 27 of said inclined magnetic suspension stabilizer 26 passes over. Since said linear guideway electric generators 17 said are made of an iron-less core and a copper coils wound around the core, said linear guideway electric generators 17 become a dynamic electric generating device and transmission line at the same time, where the electric output will be stored or recharged on a replacement battery, UPS, transformer, or electrolyze water in a water electrolysis device located strategically in every Maglev vehicle station, or used to light the guideway system, vehicle station or other electric or power needs like power the elevator or escalator and so on.

Along the line of the magnetic array spinning discs 27 is an on-board electric generator 32 being constructed similarly with said linear guideway electric generators 17 and generates electricity when passed through said passive magnetic discs assemblies 16. Said on-board generator 32 acts as an alternator to charge the on-board battery pack 33 provided on said vehicle body 25.

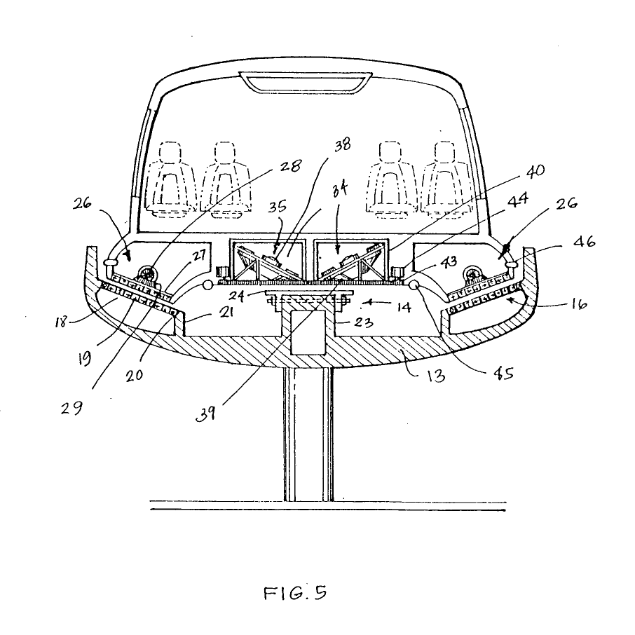

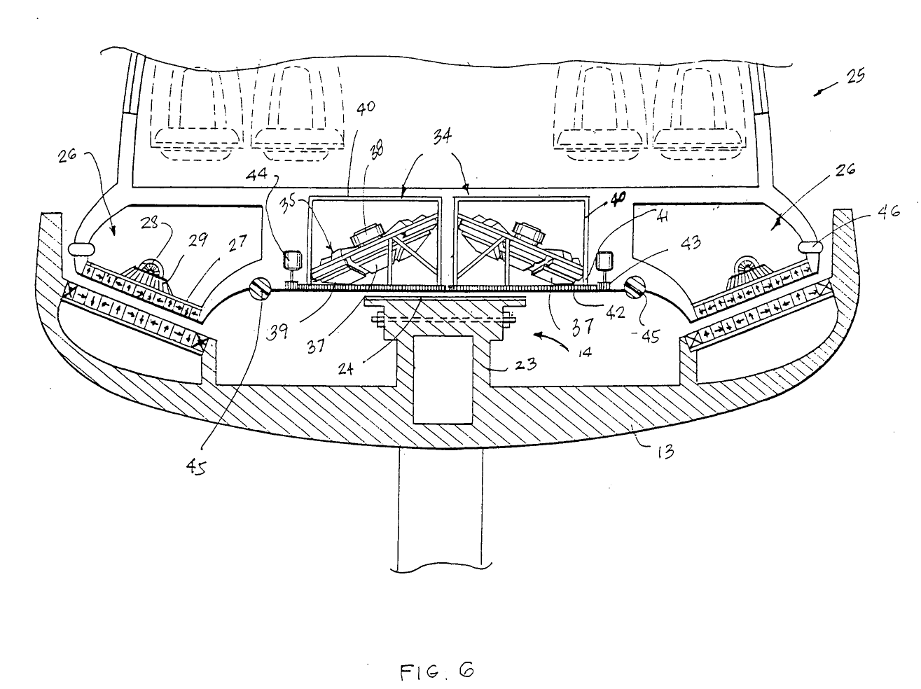

In between said magnetic suspension stabilizers 26 and at the lower portion of said vehicle body 11 is a plurality of spaced apart pairs of magnetic propulsion wheel assemblies 34. Said pair of magnetic propulsion wheel assemblies 34 are basically disposed linearly at the middle bottom portion of said vehicle body 25. Said magnetic propulsion wheel assemblies 34 are responsible for the forward and backward movement of said vehicle body 25. Each of said magnetic propulsion wheel assemblies 34 is comprised of a conical wheel 35 defined by a conical housing 36 confining a conically shaped plurality of magnetic-electromagnets 37, each being defined by a U-Shaped magnetic array 47 wound with copper wire 48 rotatably communicating with a commutator (not shown) provided therewith. Said U-shaped magnetic array 47 are supplied by electric power from an on-board battery pack 33. Said magnetic-electromagnets 37 are held together at the center thereof that is rotatably connectedto a servo or synchronous motor 38 secured thereat. As best seen in FIGS. 5 and 6 said conical wheel 35 is disposed angularly such that a portion of the surface thereof is held horizontally at the lowest portion of said magnetic propulsion wheel assembly 34. The magnetic-electromagnets 37 at this horizontal surface portion 38 are held very near the surface of the alternating North-South-North-South magnetic-ferromagnetic attractive propulsion guideway 14. Hence, once the conical wheels 35 start to rotate in the forward direction, the magnetic-electromagnets 37 would magnetically attract the propulsion guideway alternating North-South-North-South magnets 24 of said magnetic-ferromagnetic attractive propulsion guideway 14 causing the entire vehicle body 25 to move forward in levitation due to the repulsive force present between the magnetic suspension stabilizer 26 and the magnetic levitation guideway 12. Furthermore, as shown, the engagement area of the horizontal surface portion 38 of the pair of conical wheels 35 covers only the entire width of the propulsion guideway alternating North-South-North-South magnets 24. This means therefore that disengagement of the conical wheels 35 from said propulsion guideway alternating North-South-North-South magnets 24 can be attained if the said conical wheels 35 are rotated so that the horizontal surface portion 39 would be outside said propulsion guideway alternating North-South-North-South magnets 24. Such situation is ideal when said vehicle body 25 reaches a desired speed whereby its gravitational or inertial momentum would just be the one propelling said vehicle body 25.

To disengage said conical wheels 35 with the magnetic-ferromagnetic attractive propulsion guideway 14, each of said magnetic propulsion wheel assemblies 34 is provided with a cylindrical casing 40 wherein said conical wheel 35 and motor 38 are securedly disposed. The base 41 of said cylindrical casing 40 is provided with an annular gear 42 that is engageably provided with a pinion 43 and an electric motor 44 coupled thereof. The motor 44 drives the pinion 43 and rotate said cylindrical casing 40 by 180° (degrees). This will also rotate the conical wheel 35 by 180° (degrees) thereby disengaging the magnetic-electromagnets 37 with the propulsion guideway alternating North-South-North-South magnets 24 of said magnetic-ferromagnetic attractive propulsion guideway 14.

Another feature of the present invention is in the provision of rubberized landing gears 45 that are spacedly disposed below the vehicle body 25. Said rubberized landing gears 45 support said vehicle body 25 especially during loading of passengers in a loading station. This will also protect the levitation mechanisms such as the magnetic suspension stabilizer 26 and magnetic propulsion wheel assemblies 34 from damage. Side rotating or roller bumpers 46 are also provided at the sides of said vehicle body 25 to protect the sides of the vehicle body 25 from getting in contact with the guideways railing 13 during curve turns and the like.

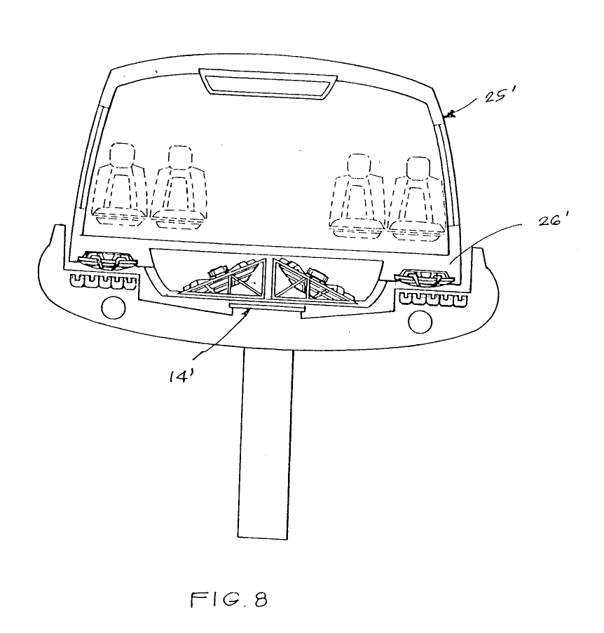

FIG. 8 shows another embodiment of the vehicle body 25′ wherein the magnetic-ferromagnetic attractive propulsion guideway 14′ and the associated magnetic suspension stabilizers 26′ are disposed in a horizontal manner.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. A magnetic levitation transport system comprising a magnetic levitation guideway, and a magnetic levitation vehicle traversing said magnetic levitation guideway;
a. said magnetic levitation guideway being defined by a pair of continuous parallel vehicle levitation guideways, each of said vehicle levitation guideways having a plurality of spaced apart passive magnetic disc assemblies, each including a magnetic disc rotatably secured thereat, each magnetic disc having a plurality of permanent magnets disposed in a circular magnetic array thereof, one or more linear guideway electric generators interconnecting said passive magnetic disc assemblies and a magnetic-ferromagnetic attractive propulsion alternating North-South-North-South magnetic guideway disposed in between said parallel vehicle levitation guideways and co-extensive with said magnetic levitation guideway; and
b. said magnetic levitation vehicle being defined by a vehicle body, a magnetic suspension stabilizer disposed at lower opposing sides of said vehicle body, said magnetic suspension stabilizer including a plurality of magnetic array spinning discs spacedly disposed in a linear pattern thereof and in levitating communication with said passive magnetic discs assemblies and in levitating communication with said linear guideway electric generators, a pinion and gear combination provided to each of said magnetic array spinning discs, a common axle rotatably secured with said pinion and gear combination, a motor coupled to said common axle, and a plurality of spaced apart pairs of rotatable magnetic propulsion wheel assemblies disposed linearly at the middle bottom portion of said vehicle body, each of said magnetic propulsion wheel assemblies having a conical wheel being defined by a conically shaped plurality of magnetic-electromagnets assembly angulary disposed thereof wherein at least a surface of each conical wheel assemby attractively communicating with said magnetic-ferromagnetic attractive propulsion guideway alternating North-South-North-South magnets, and a motor driving each conical wheel.

2. A magnetic levitation transport system according to claim 1 wherein
each of said linear guideway electric generators is defined by an iron-less core and a copper wire conductor wound around said iron-less core.

3. A magnetic levitation transport system according to claim 2 wherein
each of said linear guideway electric generators generates electricity when said plurality of magnetic array spinning discs of said magnetic suspension stabilizer passes there through using the Faraday's Law of Induction.

4. A magnetic levitation transport system according to claim 1 wherein
said magnetic-ferromagnetic attractive propulsion guideway is provided with a magnetic propulsion alternating North-South-North-South magnetic guideway thereof whereby said magnetic propulsion wheel assemblies made of magnetic array are in attractive communication.

5. A magnetic levitation transport system according to claim 1 wherein
said magnetic levitation guideway and said magnetic suspension stabilizer disposed inclinedly so that said vehicle body slides towards the center of gravity providing balance and stability of magnetic levitation.

6. A magnetic levitation transport system according to claim 1 wherein
said conical wheel being confined by a cylindrical casing, an annular gear provided at the lower portion of said cylindrical casing, a pinion engageably provided to said annular casing, and a motor coupled to said pinion causing the rotation of each conical wheel to engage and to disengange with said magnetic-ferromagnetic attractive propulsion guideway.

7. A magnetic levitation transport system according to claim 1 wherein
an on-board electric generator is provided along with said plurality of magnetic array spinning discs of said magnetic suspension stabilizer, said on-board electric generator generates electricity when subjected to the passing passive magnetic discs assemblies of said magnetic levitation guideway acting as an alternator for power supply.

8. A magnetic levitation transport system according to claim 7 wherein
a said on-board electric generator charging an on-board battery pack provided in said vehicle body.

9. A magnetic levitation transport system according to claim 1 wherein
a plurality of rolling rubberized landing gears are spacedly provided at the bottom portion of said vehicle body.

10. A magnetic levitation transport system according to claim 1 wherein
rolling or rotating side bumpers are provided spacedly at the sides of said vehicle body.

11. A magnetic levitation transport system according to claim 1 wherein
said plurality of permanent magnets of each of said passive magnetic disc assemblies are disposed in a circular Halbach array or any magnetic array configurations.

12. A magnetic levitation transport system according to claim 1 wherein
said plurality of permanent magnets of each of said passive magnetic disc assemblies are disposed in a circular magnetic-electromagnetic array.

13. A magnetic levitation transport system according to claim 1 wherein
said plurality of permanent magnets of each of said passive magnetic disc assemblies being defined by circularly formed U-shaped permanent magnets being wound by copper wire thereof.

14. A magnetic levitation transport system according to claim 1 wherein
said plurality of magnets array spinning discs of said magnetic suspension stabilizer are disposed in a circular magnetic-electromagnetic array.

15. A magnetic levitation transport system according to claim 1 wherein
said plurality of magnets array spinning discs of said magnetic suspension stabilizer are disposed in a circular Halbach array or any magnetic-electromagnetic array.

16. A magnetic levitation transport system according to claim 1 wherein
said plurality of magnets array spinning discs of said magnetic suspension stabilizer being defined by circularly formed U-Shaped permanent magnets being wound by copper wire thereof.

17. A magnetic levitation transport system according to claim 1 wherein
adjacent magnets array spinning discs of said magnetic suspension stabilizer rotating at counter directions.

18. A magnetic levitation transport system according to claim 1 wherein
each of said plurality of magnetic-electromagnets of each of said conical wheels is defined by a U-shaped electromagnet being wound by copper wire thereof.

19. A magnetic levitation transport system according to claim 1 wherein
the generated electricity output can be charged on the on board battery, UPS located at the train station and supply electricity to water electrolysis apparatus located at the station for Hydrogen production and Fuel Cell sub generation system.

20. A magnetic levitation transport system according to claim 1 wherein
the magnetic levitation guideway is inclined to attain optimum angle to maximize gravitational momentum when the maglev vehicle is traversing the said magnetic levitation gateway so as to minimize power input for magnetic propulsion just to move or push the said maglev vehicle.

21. The magnetic levitation transport system according to claim 20 wherein
the magnetic levitation transport system includes a train station which is inclined to a desired level such that a starting and a return path will also be inclined while a middle portion of the said guideway will be lower than the level of the said train station or the starting or return path.

22. The magnetic levitation transport system according to claim 21 wherein
the gravitational momentum attained on the magnetic levitation transport system makes the magnetic levitation transport system generate electricity using a linear magnetic levitation generator through the use of gravity as an external force for electric generation.

23. A magnetic levitation transport system according to claim 2 wherein
the conductor is wound using a segmented electromagnetic array with iron-less core epoxy and plastic bobbin coil winding assembly.

24. A magnetic levitation transport system according to claim 23 wherein
the coil acts as a linear stator of the said linear guideway electric generators and a magnetic array located on a body of the magnetic levitation vehicle is arranged using any magnetic array of permanent magnet in an alternating North-South-North-South sinusoidal flux density pattern that acts as a linear rotor and that is in an active non contact engagement with an iron-less core coil stator assembly.

25. The magnetic levitation transport system according to claim 24 wherein
the axial flux cutting of the magnetic field between the rotor magnetic array and the stator conductor linear generator as specified by Faraday's Law of Induction is used to generate electromotive force or electricity thereof.

26. The magnetic levitation transport system according to claim 24 wherein
the magnetic levitation guideway is enclosed in a vacuum tunnel to minimize or eliminate air resistance so as to optimize the relative speed due to gravitational momentum or acceleration due to the inclined design of the magnetic levitation guideway with respect to the Earth's gravity.

27. The magnetic levitation transport system according to claim 25 wherein
the one or more linear electric generators are wrapped with superconducting material to minimize losses due to heat thereof.
